(19) United States
(12) Patent Application Publication
(10) Pub. No.: US 2024/0373087 A1
(43) Pub. Date: Nov. 7, 2024

(54) CHECKING LOCALITY OF DEVICES

(71) Applicant: KONINKLIJKE PHILIPS N.V., EINDHOVEN (NL)

(72) Inventors: Xin Ge, Shanghai (CN); Hai Gu, Shanghai (CN); Fulong Ma, Shanghai (CN)

(21) Appl. No.: 18/690,283

(22) PCT Filed: Aug. 3, 2022
(86) PCT No.: PCT/EP2022/071793

§ 371 Date: Mar. 8, 2024

(30) Foreign Application Priority Data
Sep. 9, 2021 (WO) PCT/CN2021/117332
Oct. 28, 2021 (EP) 21205159.3

(51) Int. Cl. H04N 21/4367; G06F 1/12; H04L 9/32; H04N 21/8358

(52) U.S. Cl. CPC H04N 21/4367; G06F 1/12; H04L 9/3239; H04L 9/3297; H04N 21/8358

(57) ABSTRACT

Proposed are concepts for checking the locality of devices to determine if data (e.g. media content) can be shared between the devices, which may therefore aid secure sharing of data or media content between the devices. In particular, it is proposed that a simple way to check if two devices are in/at the same location (i.e. in close vicinity of each other) is to check if they are visible to each other. By one device displaying information to the other device, the displayed information can be used to confirm that the devices are visible to each and thus infer a shared locality. Such information may comprise (or be based on) information that should only be known to the two devices, thereby facilitating verification of the devices.

### FIELD OF THE INVENTION

The present invention relates to sharing data between different devices, and more particularly to checking the locality or vicinity of two devices to determine if data can be shared therebetween by a visual verification process.

### BACKGROUND OF THE INVENTION

Sharing data (e.g. media content) between devices (e.g. a transmitter and a receiver) via a wireless communication link is widely-known. An example of such data sharing is screen casting media content from a smartphone or portable computing device to a display (e.g. TV) that is connected to the same wireless communication network.

However, such screen casting is typically not possible for content that is protected using Digital Rights Management (DRM) tools, because, as the receiver (e.g. TV) side there may not be DRM available.

High-bandwidth Digital Content Protection (HDCP) provides a digital copy protection approach for digital audio and video content (A/V content) transmitted across cables (e.g. DVI, HDMI) in wired digital systems. HDCP attempts to prevent copy of such A/V content.

A locality check with Round Trip Time (RTT) is adopted by HDCP 2.x specification as an approach of protection of digital copyright for cable connectivity. Such kind of solutions are, for example, disclosed in U.S. Pat. No. 8,886,939 B2 assigned to Philips (Kamperman) or US2011/09668A1 assigned to Samsung (Singh, etc.).

By way of example, for a locality check between an HDCP transmitter and HDCP receiver, the HDCP transmitter, after initiating the locality check, sets a watchdog timer and waits for 20 ms before which it expects to receive a response from the HDCP receiver. The locality check is performed to ensure that content protection keys can only be exchanged if the RTT is less than 20 ms for point-to-point communication.

However, such RTT approaches are typically not applicable to wireless network environments e.g. due to unexpected network delays.

A visual authentication process is disclosed in US 2018/130168 A1, which includes a single anti-spoof apparatus that can verify the authenticity of on-the-fly scene images. According to this process, the anti-spoof apparatus projects a randomly selected watermark or an IR pattern on a person's face for visual identification, and the watermark or pattern dynamically varies to avoid replay attacks. But it fails to address the technical problem of interaction, e.g. digital media content sharing, between two neighboring devices, in which scenario the both devices from transmitter and receiver ends are supposed to be involved in a verification process.

Also, US 2017/124297 A1 discloses a verification process utilizing sonic signals to identify device IDs, which is in a level even farther more than a secret handshake for communication between two devices.

### SUMMARY OF THE INVENTION

The invention is defined by the claims.

According to examples in accordance with an aspect of the invention, there is provided a method for checking locality or vicinity of a first device and a second device to determine if data can be shared between the first and second devices via a wireless communication link. For instance, the first device can be any portable computing devices such as a smartphone, a tablet, a laptop or the like, and the second device can be a television or projector which is able to display informative images. The data to be shared between the first and second devices includes but is not limited to any media content, digital files, etc., for example a movie or a video clip transmitted by screen casting from a transmitter (e.g. a smartphone) to a receiver (e.g. a television) which are connected to a same WLAN network.

The method comprises a step of obtaining, at the first and second devices, a secret. As generally understood in the field of cryptography, a shared secret means a piece of data known only to the parties involved in a secure communication, which secret can be a password, a passphrase, a big number, or an array of randomly chosen bytes, for example see https://en.wikipedia.org/wiki/Shared_secret. In an optional example of the present invention, the secret, for example a random number, can be generated by the first device (e.g. a smartphone) and then sent from the first device to the second device (e.g. a TV set). In another optional example, the secret can also be issued from an intermediate apparatus, for example a security server, and shared to the first and second devices, for example via a Transport Layer Security (TLS) protocol.

The method further comprises a step of generating, at the second device, an irreversible value based on the secret using a non-reversible encryption algorithm. As can be understood by persons skilled in the art, the irreversible value usually means a data value not able be derived or cracked by means of inverse operation or inverse calculation. In an optional example of the invention, said irreversible value can be a hash value calculated from the shared secret by applying a hash function, for example a SHA-1 or SHA-2 algorithm. Then, displaying, at the second device, a visual representation of the irreversible value.

The method further comprises: capturing, at the first device, the displayed visual representation; and processing, at the first device, the captured visual representation to determine whether the second device is within the locality or vicinity of the first device. If it is determined that the second device is in the locality of the first device, the second device will be allowed to share data with the first device: otherwise, if it is determined that the second device is not in the locality or vicinity of the first device, the data sharing will be denied or terminated.

According to the present invention, the concept of “locality” or “vicinity” can be typically understood as that the first and second devices are located within a visible range so that the first device can directly capture an image displayed at the second device, for example in the same room or within a limited sized area. In an optional example, the first device may comprise a camera or be connected to a local camera, which is pointed to the display or screen of the second device.

Processing the captured visual representation at the first device comprises: extracting the irreversible value from the captured visual representation: generating a verification value from the secret using the same non-reversible encryption algorithm: comparing the verification value and the extracted irreversible value to determine if the second device is within the locality of the first device. If the verification value matches the extracted irreversible value, it can be determined that the second device is in the locality or vicinity of the first device. Otherwise, if the verification value doesn't match the extracted irreversible value, it can be determined that second device is not in locality or vicinity of the first device.

Proposed concepts thus aim to provide schemes, solutions, concepts, designs, methods and systems pertaining to checking locality of a first device and a second device to determine if data (e.g. media content) can be shared between the first and second devices. In particular, embodiments of the invention propose robust locality checking concepts which do not rely on a network environment (unlike the conventional approach in DTCP locality checking).

In particular, it is proposed that a simple way to check if two devices are in/at the same location (i.e. in a close vicinity to each other) is to check if they are visible to each other. That is, if one device is visible to another device, such co-visibility (i.e. the ability of one device to see the other) provides strong evidence that the two devices are in the same location (i.e. share the same locality). By one device displaying information to the other device, the displayed information can be used to confirm that the devices are visible to each and thus infer a shared locality. Such information may comprise (or be based on) information that should only be known to the two devices, thereby facilitating verification of the devices.

For instance, it is proposed that a shared secret may be made available to the two devices, and the visual display of information using the secret may enable one device to check if the other device is at the same locality. In this way, the locality of two devices can be verified.

This technical proposal may be especially useful e.g. for establishing secret communications between two devices in a vicinity or same location, e.g. a room of an end-user who is owner of the two devices, e.g. a television display and a mobile phone. Embodiments may therefore check if two devices are in/at the same location (e.g. in the same room) so as to determine if data (e.g. media content) can be shared between the devices. The proposed locality checking concept(s) may thus aid secure sharing of data or media content between two devices.

Proposed embodiments may provide the advantage that a locality check of two (or more devices) can be undertaken in a simple and secure manner using a visual checking concept. Such locality checking may cater for securely sharing multimedia content between devices. By way of example, the proposed concept(s) may support screen casting from a portable computing device. e.g. mobile phone, to another device. e.g. a TV. Through the use of the proposed locality checking concept(s), the data content may only be shared in a local area (i.e. shared location) to prevent/avoid abuse of the sharing per a data content provider's request.

In other words, embodiments propose a visual-based locality checking approach that may aid controlled, restricted and/or secures sharing of data between devices. Accordingly, embodiments may be used in relation to local data sharing (e.g. screen casting) so as to protection against unauthorised copying and/or sharing of data. Such embodiments may also support copyright protection. Improved copyright protection or digital rights management may therefore be provided by proposed concepts.

In some embodiments, the analyzing may comprise: generating a verification value based on the secret: comparing the verification value and the extracted irreversible value to determine a comparison result; and determining that the second device is in the locality of the first device if the two values match each other. That is, the first device may verify that the irreversible value provided by the second device matches an expected value. For instance, a simple hashing function may be applied to the secret at the first and second device in order to generate respective values at the first and second devices. With the display of the generated value at the second device, the first device can ascertain whether or not the displayed value is as expected (by making a comparison of the values).

By way of example, if the comparison result indicates the verification value matches the extracted irreversible value, it may be determined that the second device is within the locality of the first device. Conversely, if the comparison result indicates the verification value does not match the extracted irreversible value, it may be determined that the second device is not within the locality of the first device.

Some embodiments may further comprise generating, at the second device, a second device timestamp value, and the irreversible value may be generated at the second device based on both the shared secret and the second device timestamp value. In such a way the visual representation displayed by the second device will include its timestamp information embedded therein for an additional verification of possible time delay.

Accordingly, processing the captured visual representation may then comprise: generating a first device timestamp value at the first device, for example, to keep a time record of when it captures the visual representation from the second device; and then generating, at the first device, the verification value based on both the secret and the first device timestamp value, so that the verification value will include the timestamp information of the first device as well, for the additional verification of time delay. Such an approach may be especially useful, for example, in a case where a user encounters an attempt to feign/fake the locality/vicinity check by capturing the visual representation by a third party's device and forwarding the visual representation to a different location, for example to a remote device (for subsequent display at the different location). Such kind of faking attempt can be prevented by incorporating corresponding timestamp information of the first and second devices and conducting a time verification in addition to verification of the shared secret. In particular, use of the timestamp information may facilitate a check for the presence of a possible time delay caused by capture and transmission of the visual representation to another location. Embodiments may therefore be adapted to protect against attempts to undermine or otherwise defy the proposed locality checking method(s).

Furthermore, in an optional embodiment, the second device may refresh the visual representation by repeating the step of generating the irreversible value after every short time period, such as to realize a dynamic visual verification. For example, the second device may periodically repeat the steps of generating the second device timestamp value and calculating the irreversible value from the shared secret and the second device timestamp value.

Yet further, some embodiments may also comprise rounding at least one of the first and second timestamp values according to a target accuracy value. In this way, time values may be pre-processed to meet precision requirements, thus catering for different applications.

To aid or improve accuracy of the use of timestamps, embodiments may further comprise: synchronizing a reference clock of the first and second devices. The first and second device timestamp values may then be generated based on the synchronized reference clock of the first and second devices, respectively. In this way, discrepancies between reference clocks or timers used by the first and second devices may be avoided, thus improving accuracy.

In some exemplary embodiments, displaying a visual representation of the irreversible value may comprise: generating an image comprising a watermark, the watermark having the irreversible value embedded therein; and displaying, as the visual representation of the irreversible value, the generated image with watermark. By way of example, the watermark may be generated using a fragile watermarking technique. Such an approach may, for example, be utilized to counter an attempt to feign/fake locality by capturing the visual representation and transmitting the visual representation to a different location (for subsequent display at the different location). In particular, use of a watermark may facilitate a check for the presence of a corruption of the visual representation (e.g, increased image noise, reduction in image quality, etc.) caused by its capture and transmission of the visual representation to another location. Embodiments may thus be adapted to protect against attempts to undermine or otherwise defy the proposed locality checking method(s).

Also, processing the captured visual representation may comprise: detecting the presence of the watermark in the captured visual representation: responsive to not detecting the presence of the watermark, determining that the second device is not within the locality of the first device; and responsive to detecting the presence of the watermark, extracting the irreversible value from the detected watermark. In this way, a watermark may provide a hidden authentication object that has a dual-purpose. e.g. authentication of the visual representation and carrier of the irreversible value.

In other exemplary embodiments, displaying a visual representation of the irreversible value may comprise: generating a machine-readable code comprising the irreversible value; and displaying, as the visual representation of the irreversible value, the machine-readable code. For example, the machine-readable code may comprise a linear barcode and/or a 2D matrix code. Efficient visual representations of information that are not readable by a human may thus be employed, thereby protecting the irreversible value from being visually read/understood by a human. This may provide additional protection against attempts to undermine, reverse-engineer or hack the proposed locality checking method(s).

Some embodiments may further comprise a step of generating the secret at the first device or at the second device. Thus, the secret may be generated by either of the devices. Alternatively, in other embodiments, the secret may be obtained from another source (e.g, a trusted server). The proposed concept(s) thus cater for the provision of the secret to the devices in many different ways.

Purely by way of example, the first device may comprise a mobile computing device, which for example can be a smartphone, a tablet, a laptop or the like, and the second device may comprise a display device having communication interface configured to receive the communicated secret, which for example can be a television, a projector, a PC or a laptop, etc. Embodiments may thus be used to support screen sharing, or screen casting, from a mobile phone to a smart television, for example, wherein distribution of the shared content to other remotely-located devices can be prevented.

According to examples in accordance with another aspect of the invention, there is provided a method for establishing a communication link between a first device and a second device. The method comprises checking locality or vicinity of the first device and the second device according to a proposed embodiment: responsive to determining that the second device is within the locality of the first device, establishing a communication link between the first device and the second device; and responsive to determining that the second device is not within the locality of the first device, preventing establishment of a communication link between the first device and the second device.

Thus, there may be provided concepts for ensuring that a communication link (e.g. for communication media content) between two devices is only established if the devices are in the same locality (i.e. share the same general location).

According to another aspect, there is provided a computer program product for, wherein the computer program product comprises a computer-readable storage medium having computer-readable program code embodied therewith, the computer-readable program code configured to perform all of the steps of a proposed embodiment.

Thus, there may also be provided a computer system comprising: a computer program product according to proposed embodiment; and one or more processors adapted to perform a method according to a proposed concept by execution of the computer-readable program code of said computer program product.

According to another aspect of the invention, there is provided a first device configured to check the locality of the first device and a second device for determining if data can be shared between the first and a second device. The first device comprises a first processing unit configured to control the first device to: generate a secret and then share the secret with the second device: capture a visual representation an irreversible value displayed by the second device: extract the irreversible value from the captured visual representation, wherein the irreversible value is supposed to be generated at the second device based on the shared secret using a non-reversible encryption algorithm: generate a verification value based on the secret using the same non-reversible encryption algorithm: compare the verification value and the extracted irreversible value to determine that the second device is in the locality of the first device if the verification value matches the extracted irreversible value. The first device may for example, comprise a mobile computing device (such as a smartphone, a tablet, a laptop or the like).

According to another aspect of the invention, there is provided a second device configured to share data between a first and the second device. The second device comprises a second processing unit configured to control the second device to: obtain a secret: generate an irreversible value based on the secret using a non-reversible encryption algorithm: display a visual representation of the irreversible value; and share data with the first device if the first device verifies that the second device is in locality of the first device. The second device may, for example, comprise a display device having a communication interface configured to receive the secret (e.g, a ‘smart’ TV).

According to yet another aspect of the invention, there may be provided a data sharing system comprising the first device according to a proposed embodiment and the second device according to a proposed embodiment. The first device may thus check the locality or vicinity of the first device and the second device so as to determine where data is permitted to be shared between the first and second devices. Embodiments may therefore provide part or all of a data sharing system for sharing or streaming media content between two nearby devices. That is, embodiments may provide apparatus for local sharing (i.e. streaming or screencasting) of multimedia content between two devices, wherein the apparatus is configured to check that the two devices are the same locality.

These and other aspects of the invention will be apparent from and elucidated with reference to the embodiment(s) described hereinafter.

### BRIEF DESCRIPTION OF THE DRAWINGS

For a better understanding of the invention, and to show more clearly how it may be carried into effect, reference will now be made, by way of example only, to the accompanying drawings, in which:

FIG. 1 depicts an exemplary embodiment of checking locality of a first device and a second device to determine if data can be shared between the first and second devices;

FIG. 2 is a flow diagram of a method for checking locality of a first device and a second device according to an embodiment;

FIG. 3 depicts the process steps of a method for checking locality of a first device and a second device according to another embodiment;

FIG. 4 depicts the process steps of a method for checking locality of a first device and a second device according to yet another embodiment; and

FIG. 5 is a simplified block diagram of a computer within which one or more parts of an embodiment may be employed.

### DETAILED DESCRIPTION OF THE EMBODIMENTS

The invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. The mere fact that certain measures are recited in mutually different dependent claims does not indicate that a combination of these measures cannot be used to advantage.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality.

It should be understood that the Figures are merely schematic and are not drawn to scale. It should also be understood that the same reference numerals are used throughout the Figures to indicate the same or similar parts.

The invention proposes concepts for checking the locality or vicinity of devices to determine if data (e.g. media content) can be shared between the devices, which may therefore aid secure sharing of data or media content between the devices. In particular, embodiments may provide a method and/or system which employs a visual-based verification approach, and this may support the secure sharing of data or multimedia content between devices.

In particular, proposed concepts may provide an approach to checking locality or vicinity of a first device and a second device to determine if data (e.g. media content) can be shared between the devices. Accordingly, embodiments may be used in relation to screen casting and/or provide improved local data/content sharing functionalities.

By way of example only, illustrative embodiments may be utilized in many different types of data/content sharing environments, such as a person's home, a workplace, a clinical/medical environment, a manufacturing or engineering facility, etc.

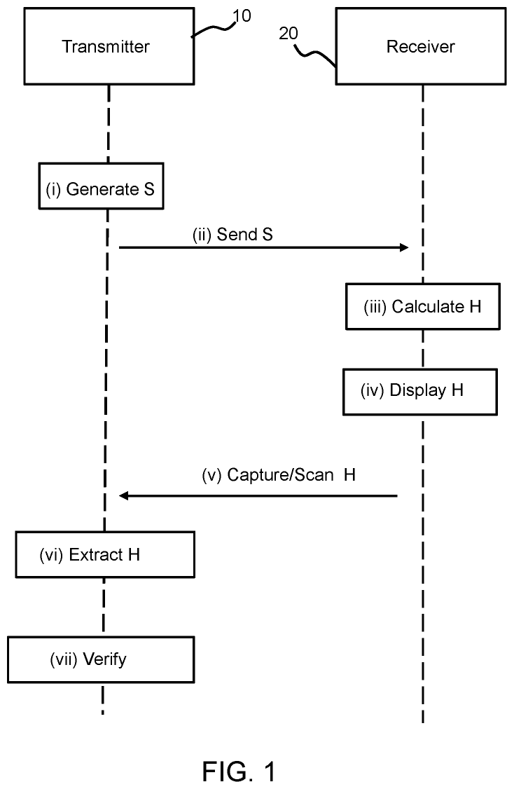

Referring to FIG. 1, there is depicted an exemplary embodiment of checking locality of a first device 10 and a second device 20 to determine if data can be shared between the first and second devices. In this example embodiment, the first device 10 is a transmitter such as a portable computing device like a smartphone, a tablet or a laptop, which may comprise or connected to a camera or image scanner, and the second device 20 is a receiver such as a television or a projector which can display an image or a visible code. The first and second devices can be connected via a wireless communication link such as Wi-Fi, 3G/4G/5G network or Bluetooth.

The main process steps of the exemplary embodiment may be summarized as follows:
(i) The transmitter 10 firstly generates a secret S;
(ii) The transmitter 10 then sends the secret S to the receiver;
(iii) The receiver 20 receives the secret S and creates an irreversible value H using the secret S (e.g. by hash calculation);
(iv) The receiver 20 displays a visual representation (e.g, an image, a watermark or a QR code) of the irreversible value H on a display screen of the receiver;
(v) The transmitter 10 captures/scans the displayed image;
(vi) The transmitter 10 extracts the irreversible value H from the captured/scanned image;
(vii) The transmitter 10 verifies the extracted irreversible value H by comparing it against the secret S. If extracted irreversible value H matches an expected value (based on the same secret S), the verification process is passed, otherwise the verification process is failed, and data sharing is denied or terminated.

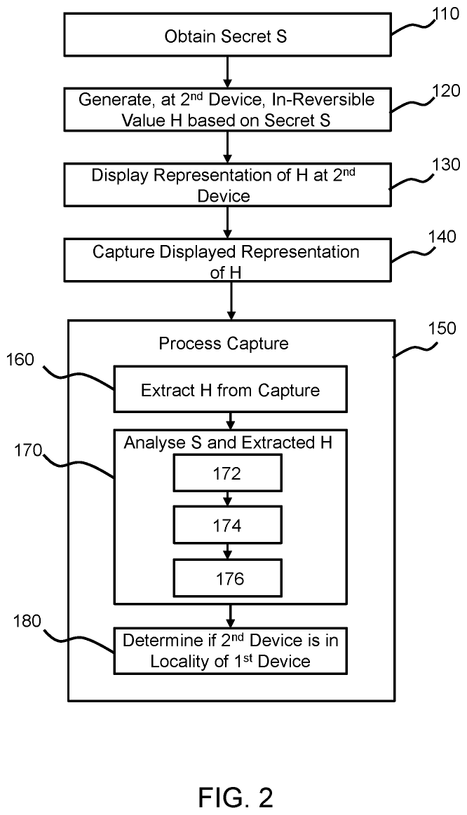

By way of further explanation of the proposed concept(s), an exemplary embodiment of a method for checking locality of a first device and a second device will now be describe with reference to FIG. 2.

FIG. 2 depicts a flow diagram of a method for checking locality of a first device and a second device according to an embodiment. The check for locality can be used to determine if data can be shared between the first and second devices.

The first step 110 of the method comprises obtaining, at the first and second devices, a secret S. For instance, the first device may generate the secret S and then communicate the secret S to the second device, or vice versa. Alternatively, the first and second devices may each retrieve the secret S from a trusted source, e.g, trusted server, via a secure communication link or the Internet.

Step 120 then comprises generating, at the second device, an irreversible value H based on the secret S. This may, for example, comprise using a hashing function to generate a hash value H using the secret S.

In step 130, a visual representation of the irreversible value H is displayed at the second device, e.g. via a display screen of the second device.

The displayed visual representation is then captured by the first device in step 140, e.g. using an image capture device such a digital camera.

At the first device, the captured visual representation is then processed in step 150 to determine if the second device is within the locality or vicinity of the first device.

In this example, the step 150 of processing the captured visual representation comprises three sub steps: (step 160) extracting the irreversible value H from the captured visual representation; (step 170) analyzing the secret S and the extracted irreversible value H to determine an analysis result; and (step 180) determining if the second device is in the locality of the first device based on the analysis result.

Specifically, the step 170 of analyzing comprises: (step 172) generating a verification value Hv based on the secret S: (step 174) comparing the verification secret Hv and the extracted irreversible value H to determine a comparison result; and (step 176) determining if the second device is in the locality of the first device based on the comparison result. Here, if the comparison result indicates that the verification secret Hv matches the extracted irreversible value H, it is determined that the second device is within the locality of the first device. Conversely, if the comparison result indicates that the verification secret Hv does not match the extracted irreversible value H, it is determined that the second device is not within the locality of the first device.

To tackle counterfeiting of the displayed visual representation, two exemplary options may be employed: (1) an embodiment may be extended with a time delay check: or (2) use of a watermark, such as a watermark that is sensitive to capture operations (i.e. a fragile watermark that prevents secondary capture).

By way of example of option (1) above, an extension of a proposed method which employs a time delay check may be summarized as follows:
(i) The first and second device each have a mechanism for time synchronizing;
(ii) The first device generates a secret S;
(iii) The first device then communicates information to the second device including the secret S;
(iv) The second device generates a timestamp value T and then calculates a hash value H from the secret S and the timestamp value T by applying a hash function;
(v) The second device displays a visual code such as a QR code representing the hash value H. Here it is noted that the second device may repeat the steps of generating the timestamp value T and calculating the hash value H after every short time period, e.g. 1 second, if the locality check is not completed, and thus refresh the displayed QR code according to the re-calculated hash value H;
(vi) The first device uses a camera to scan the QR code and parses the captured QR to extract the hash value H, and in the meantime records a timestamp value T′ of doing so.
(viii) The first device calculates its own hash value H′ based on the secret S and the recorded timestamp value T′ by applying the same hash function.
(ix) The first device then compares the two hash values H and H′ to check if they match each other or not.
(x) If the locality check result is deemed positive (i.e. the compared hash values match), it is determined that the first and second devices are in the same locality or in a close vicinity and screen casting (e.g. from the first device to the second device) is permitted. Otherwise, if the locality check result is deemed negative (i.e. the compared hash values do not match), it is determined that the first and second devices are not in the same locality and screen casting is denied or terminated.

By way of example of option (2) above, an embedded watermark may be adapted to be sensitive to operations. For instance, the watermark may be configured so that image capture adds noise to the watermark. That is, a fragile watermark may be employed to not emphasize robustness, such that the watermark is not robust enough to support a second capture. In this way, a double-copy of the image will make the watermark undetectable, thereby preventing any copy action.

There are many known fragile watermark algorithms and so detailed discussion of the various fragile watermarking techniques are hereby omitted for the purpose of conciseness. However, it will be understood that it may be preferable to configure the watermarking technique so that it has an appropriate threshold value for judging the detection successful or not. Tests may therefore be preferred in order to determine an appropriate watermarking technique depending on implementation specifics (e.g. to produce a watermark that is detectable/usable in a first capture, but then undetectable/unusable in subsequent capture (i.e. capture of the first capture).

As an example of option (2), an extension of a proposed method which employs a watermark may be summarized as follows:
(i) The first device firstly sends a random nonce to the second device;
(ii) The second device embeds the nonce with the form of watermark into a specific image, then displays the image (with watermark) on a display screen;
(iii) The first device then captures/scans the display screen;
(iv) If the watermark is detected in the scan/capture, the watermark is extracted and the nonce value checked. If value is the same, check is OK, otherwise the locality check is failed;
(v) If the watermark is not detected in the scan/capture, locality check is failed.

In some cases the timestamp information used in option (1) above can also be added to the watermark option (2). But in a scenario of fragile watermark, noise will be introduced to the visual representation to avoid a second time capturing, and the timestamp information might not be necessary.

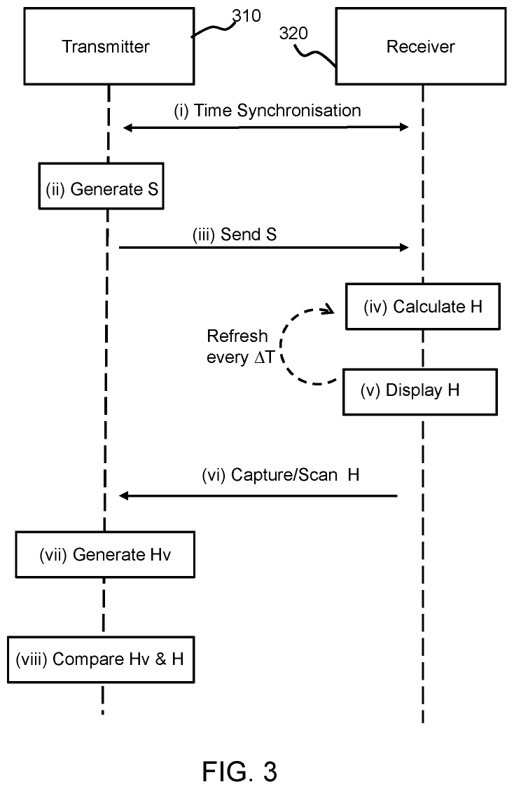

By way of yet further example of the proposed concept(s), an exemplary embodiment of a method for checking locality of a first device and a second device will now be described with reference to FIG. 3.

FIG. 3 depicts the process steps of a method for checking locality of a first device 310 and a second device 320 according to an embodiment. In this example embodiment, the first device 310 is a mobile phone comprising a transmitter, and the second device is a smart TV comprising a receiver.

Here, it is noted that, before beginning the whole procedure, it may be preferable for the transmitter to start a timer with a timeout value (e.g. 20 seconds). If the timer is out, the transmitter can then restart the check procedure with a new generated nonce.

The main process steps of the exemplary embodiment may be summarized as follows:
(i) The transmitter 310 and the receiver 320 each have a mechanism for time synchronization. In this way, a reference clock of the transmitter 310 and the receiver 320 can be synchronized. Such time synchronization can be done in many ways, but purely way of example, a NTP protocol may be used so that each device gets an accurate time from a trusted internet time source.
(ii) The transmitter 310 generates a secret S, such as a random number which is not known by other devices.
(iii) The transmitter 310 sends the secret S to the receiver 320.
(iv) The receiver 320 calculates the hash H based on the secret S and a timestamp value T (corresponding to the time that the receiver undertakes the calculation of the hash H). By way of example, the timestamp value T normally may be represented as a number, e.g, the seconds since 00:00:00 Jan. 1, 1970. H can then be calculated using some hash algorithm, such as the following equation:

$$H = SHA - 256 ( S \vert T ) , \qquad ( 1 )$$

where S and T are represented in string and | is a concatenation.
(v) A QR code (or other machine readable code) comprising the H value is then displayed by the receiver 320.

The receiver 320 repeat steps (iv) and (v) after a short time period ΔT (e.g. 1-5 seconds) so as to refresh the hash H and thus refresh the QR code. Here, the time period ΔT may be selected so that it prevents a user taking a photo of the QR code and sending it to a remote user to scan. Thus, by way of example, a time period ΔT in the range of 1-5 seconds may be appropriates. However, shorter time periods, such as 0.1 seconds, 0.5 seconds, etc., may be preferable in some embodiments. Conversely, other embodiments may employ longer time periods (i.e. larger values for ΔT).

Also, in some embodiments, the timestamp values may be pre-processed to have the same precision as the time period. For instance, if the time period ΔT is 1 second, the precision will be Is. If the time Toriginal is represented using milliseconds, and the time period is selected as t milliseconds, T can then be calculated as:

$$T = Round ( Torigial / t ) * t \qquad ( 2 )$$

(vi) The transmitter 310 uses a camera to scan the displayed QR code and thus capture get H. At the same time, the transmitter 310 also generates its own timestamp value T′, thus identifying the time of scan/capture by the transmitter 310. If the transmitter 310 is in the same locality, it's timestamp value T′ should be the approximately same as the time T in the QR code. Typically, the system delay may be in the order of milliseconds, and so T and T′ may differ by a small amount (e.g. milliseconds).
(vii) The transmitter calculates its own hash H′ based on T′ and S. H′ is calculated using the same method as above for calculating H at the receiver, e.g.:

$${H}^{′} = SHA - 256 ( S \vert {T}^{′} ) \qquad ( 3 )$$

If T was rounded using (2) above, then T′ should also be processed using (2) before undertaking the calculation of equation (3).

With this approach, the H′ should be the same as H, if the transmitter 310 and the receiver 320 are in the same locality (because T should be the same as T′). If a remote user tries to view the content, e.g. by taking a photo of the QR code and send to the valid device for scanning, there will be a significant delay Tdelay to take photo and send the photo, so T′=T+Tdelay. As a result, T′ will not equal T, so H will not equal H′, thus causing the locality check to fail.
(viii) The transmitter 310 compares H and H′. If H and H′ are the same, the locality check result is positive, and it is thus determined that the transmitter 310 and the receiver 320 are in the same locality. Otherwise, the result is negative, and it is thus determined that the transmitter 310 and the receiver 320 are not in the same locality.

In other embodiments, the transmitter 310 may calculate multiple hash values H′ using a wide selection of timestamp values T′, e.g. by addition 1-n delay of short time periods t, using the following equations:

$$\begin{matrix}{T}^{′} n = {T}^{′} + n * t . & ( 4 ) \\ {H}^{′} n = SHA - 256 ( S \vert {T}^{′} n ) & ( 5 )\end{matrix}$$

Then, if H equals any of H′n, the locality check is passed.

Checking is usually part of the entire negotiation procedure before screen casting.

Suppose both sides (i.e. both first and second devices) have exchanged a shared key that can be used as encryption Key for watermark processing. A watermark can be employed as part of the checking process. For example, embodiments may comprise detecting the presence of the watermark in the captured visual representation. Responsive to not detecting the presence of the watermark, it may be determining that the second device is not within the locality of the first device.

Such watermarks may use many different forms of identification information. For example, a random nonce (e.g. 64 bits) may be used as a watermark.

Both sides may have stored the original image for later use of watermark embedding and extraction. For improved capture by phone camera, a created image (i.e. visual representation of H) with watermark may be only displayed in part of the display screen. By arranging display of a watermark in a specific display area by default, detection may be simplified.

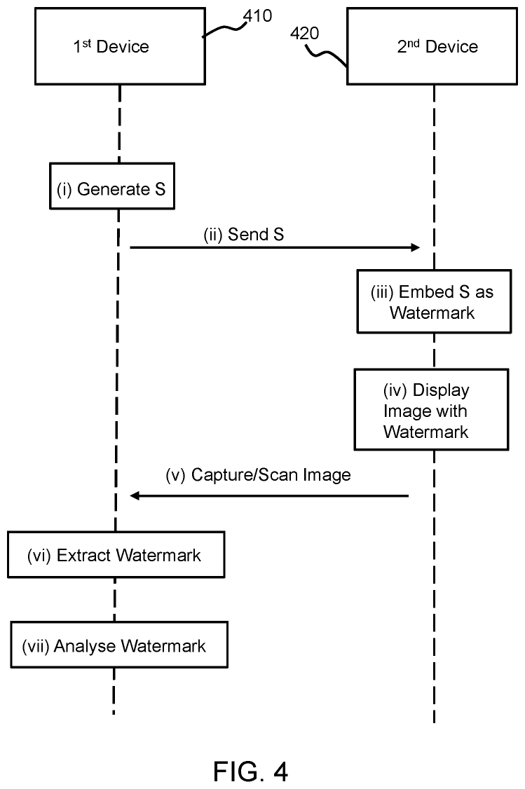

By way of example, of an exemplary embodiment employing a watermark will now be described with reference to FIG. 4.

FIG. 4 depicts the process steps of a method for checking locality of a first device 410 and a second device 420 according to an embodiment. In this example embodiment, the first device 410 is a laptop computer, and the second device is a tablet computer.

The main process steps of the exemplary embodiment of FIG. 4 may be summarized as follows:
(i) The first device 410 generates a secret S, which in this example is a random nonce N1;
(ii) The first device 410 sends the secret S (i.e. N1) to the second device 420.
(iii) The second device 420 uses a watermarking module to embed the secret (i.e. N1) as a watermark in a prepared image, thereby generating a visual representation of the secret S
(iv) The second device 420 displays the generated image (with embedded watermark) in the central area of its display screen;
(v) The first device 410 scans/captures the image displayed by the second device.
(vi) The first device 410 extracts the watermark. If the watermark is not detected, locality check process is failed;
(vii) The first device analyses the extracted watermark. Specifically, the first device 410 compares the extracted watermark with the secret S (i.e. N1) to determine if the secret embedded in the watermark matches that generated at the first device. If the comparison result confirms the secrets match, the locality check is passed. Otherwise, the locality check is failed.

If a fragile watermarking technique is employed, the first device 410 will not detect an effective watermark if it scans/captures a re-captured image (instead of the display of the second device).

Thus, according to the proposed concept(s), a display of a second device may be employed to display an irreversible value for checking locality of the second device against another device (e.g, a first device). A proposed locality checking method may use a secret value and a displayed irreversible value to determine if devices are in the same locality of the display. This can be used to determine if data can be shared between the devices. Also provided is a system that implements the proposed concept(s) for checking locality of two (or more) devices)

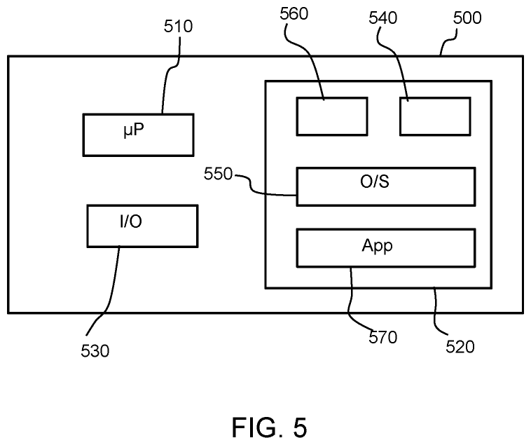

FIG. 5 illustrates an example of a computer 500 within which one or more parts of an embodiment may be employed. Various operations discussed above may utilize the capabilities of the computer 500. For example, one or more parts of a system for providing a subject-specific user interface may be incorporated in any element, module, application, and/or component discussed herein. In this regard, it is to be understood that system functional blocks can run on a single computer or may be distributed over several computers and locations (e.g. connected via internet).

The computer 500 includes, but is not limited to, PCs, workstations, laptops, PDAs, palm devices, servers, storages, and the like. Generally, in terms of hardware architecture, the computer 500 may include one or more processors 510, memory 520, and one or more I/O devices 570 that are communicatively coupled via a local interface (not shown). The local interface can be, for example but not limited to, one or more buses or other wired or wireless connections, as is known in the art. The local interface may have additional elements, such as controllers, buffers (caches), drivers, repeaters, and receivers, to enable communications. Further, the local interface may include address, control, and/or data connections to enable appropriate communications among the aforementioned components.

The processor 510 is a hardware device for executing software that can be stored in the memory 520. The processor 510 can be virtually any custom made or commercially available processor, a central processing unit (CPU), a digital signal processor (DSP), or an auxiliary processor among several processors associated with the computer 500, and the processor 510 may be a semiconductor based microprocessor (in the form of a microchip) or a microprocessor.

The memory 520 can include any one or combination of volatile memory elements (e.g., random access memory (RAM), such as dynamic random access memory (DRAM), static random access memory (SRAM), etc.) and non-volatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 520 may incorporate electronic, magnetic, optical, and/or other types of storage media. Note that the memory 520 can have a distributed architecture, where various components are situated remote from one another, but can be accessed by the processor 510.

The software in the memory 520 may include one or more separate programs, each of which comprises an ordered listing of executable instructions for implementing logical functions. The software in the memory 520 includes a suitable operating system (O/S) 550, compiler 540, source code 560, and one or more applications 570 in accordance with exemplary embodiments. As illustrated, the application 570 comprises numerous functional components for implementing the features and operations of the exemplary embodiments. The application 570 of the computer 500 may represent various applications, computational units, logic, functional units, processes, operations, virtual entities, and/or modules in accordance with exemplary embodiments, but the application 570 is not meant to be a limitation.

The operating system 550 controls the execution of other computer programs, and provides scheduling, input-output control, file and data management, memory management, and communication control and related services. It is contemplated by the inventors that the application 570 for implementing exemplary embodiments may be applicable on all commercially available operating systems.

Application 570 may be a source program, executable program (object code), script, or any other entity comprising a set of instructions to be performed. When a source program, then the program is usually translated via a compiler (such as the compiler 540), assembler, interpreter, or the like, which may or may not be included within the memory 520, so as to operate properly in connection with the O/S 550. Furthermore, the application 570 can be written as an object oriented programming language, which has classes of data and methods, or a procedure programming language, which has routines, subroutines, and/or functions, for example but not limited to, C, C++, C#, Pascal, BASIC, API calls, HTML, XHTML, XML, ASP scripts, JavaScript, FORTRAN, COBOL, Perl, Java, ADA, .NET, and the like.

The I/O devices 530 may include input devices such as, for example but not limited to, a mouse, keyboard, scanner, microphone, camera, etc. Furthermore, the I/O devices 530 may also include output devices, for example but not limited to a printer, display, etc. Finally, the I/O devices 530 may further include devices that communicate both inputs and outputs, for instance but not limited to, a NIC or modulator/demodulator (for accessing remote devices, other files, devices, systems, or a network), a radio frequency (RF) or other transceiver, a telephonic interface, a bridge, a router, etc. The I/O devices 530 also include components for communicating over various networks, such as the Internet or intranet.

If the computer 500 is a PC, workstation, intelligent device or the like, the software in the memory 520 may further include a basic input output system (BIOS) (omitted for simplicity). The BIOS is a set of essential software routines that initialize and test hardware at startup, start the O/S 550, and support the transfer of data among the hardware devices. The BIOS is stored in some type of read-only-memory, such as ROM. PROM. EPROM. EEPROM or the like, so that the BIOS can be executed when the computer 500 is activated.

When the computer 500 is in operation, the processor 510 is configured to execute software stored within the memory 520, to communicate data to and from the memory 520, and to generally control operations of the computer 500 pursuant to the software. The application 570 and the O/S 550 are read, in whole or in part, by the processor 510, perhaps buffered within the processor 510, and then executed.

When the application 570 is implemented in software it should be noted that the application 570 can be stored on virtually any computer readable medium for use by or in connection with any computer related system or method. In the context of this document, a computer readable medium may be an electronic, magnetic, optical, or other physical device or means that can contain or store a computer program for use by or in connection with a computer related system or method.

The application 570 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium.

The methods of FIGS. 1 to 4, may be implemented in hardware or software, or a mixture of both (for example, as firmware running on a hardware device). To the extent that an embodiment is implemented partly or wholly in software, the functional steps illustrated in the process flowcharts may be performed by suitably programmed physical computing devices, such as one or more central processing units (CPUs) or graphics processing units (GPUs). Each process—and its individual component steps as illustrated in the flowcharts—may be performed by the same or different computing devices. According to embodiments, a computer-readable storage medium stores a computer program comprising computer program code configured to cause one or more physical computing devices to carry out an encoding or decoding method as described above when the program is run on the one or more physical computing devices.

Storage media may include volatile and non-volatile computer memory such as RAM, PROM, EPROM, and EEPROM, optical discs (like CD, DVD, BD), magnetic storage media (like hard discs and tapes). Various storage media may be fixed within a computing device or may be transportable, such that the one or more programs stored thereon can be loaded into a processor.

To the extent that an embodiment is implemented partly or wholly in hardware, the functions of one block shown in the drawings may be divided between multiple components in an implementation, or the functions of multiple blocks shown in the drawings may be combined in single components in an implementation. Hardware components suitable for use in embodiments of the present invention include, but are not limited to, conventional microprocessors, application specific integrated circuits (ASICs), and field-programmable gate arrays (FPGAs). One or more blocks may be implemented as a combination of dedicated hardware to perform some functions and one or more programmed microprocessors and associated circuitry to perform other functions.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage. If a computer program is discussed above, it may be stored/distributed on a suitable medium, such as an optical storage medium or a solid-state medium supplied together with or as part of other hardware, but may also be distributed in other forms, such as via the Internet or other wired or wireless telecommunication systems. If the term “adapted to” is used in the claims or description, it is noted the term “adapted to” is intended to be equivalent to the term “configured to”. Any reference signs in the claims should not be construed as limiting the scope.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A method comprising: {first device; transmitter}
obtaining a secret;
capturing a visual representation;
extracting a hash from the visual representation,
wherein the hash is generated by an irreversible encryption,
wherein the hash is based on the secret;
generating a verification value,
wherein the verification value is generated by the irreversible encryption,
wherein the verification value is based on the secret; and
comparing the verification value and the hash, wherein if the verification value matches the hash then the second device is in the locality of the first device.

2. The method of claim 1,
wherein the hash is based on the secret and a second device timestamp value (T2),
wherein the generating of the verification value comprises:
generating a first device timestamp value (T1); and
generating the verification value based on the secret and the first device timestamp value (T1).

3. The method of claim 2, further comprising rounding at least one of the first timestamp value and the second timestamp value according to a target accuracy value.

4. (canceled)

5. The method of claim 2, further comprising:
synchronizing a first reference clock; and
synchronizing a second reference clock of the second device,
wherein the first device timestamp value (T1) is generated base on the first synchronized reference clock,
wherein the second (T2) device timestamp value is generated based on the second synchronized reference clock.

6. (canceled)

7. (canceled)

8. The method of claim 1 further comprising:
detecting the presence or absence of a watermark in the visual representation;
determining that the second device is not within the locality of the first device if the watermark is not detected in the visual representation; and
extracting the hash from the watermark if the watermark is detected.

9. (canceled)

10. The method of claim 1, further comprising:
establishing a communication link between a first device and a second device when the second device is in the locality of the first device; and
preventing establishment of a communication link between the first device and the second device when the second device is not in the locality of the first device.

11. A computer program stored on a non-transitory medium, wherein the computer program when executed on a processor performs the method as claimed in claim 1.

12. A first device comprising:
a processor circuit and a memory circuit, wherein the memory is arranged to store instructions for the processor circuit,
wherein the processor circuit is arranged to generate a secret,
wherein the processor circuit is arranged to send the secret to the second device,
wherein the processor circuit is arranged to capture a visual representation,
wherein the processor circuit is arranged to extract an hash from the visual representation,
wherein the hash is generated by an irreversible encryption,
wherein the hash is based on the shared secret,
wherein the processor circuit is arranged to generate a verification value,
wherein the verification value is generated by the irreversible encryption,
wherein the verification value is based on the secret,
wherein the processor circuit is arranged to compare the verification value and the hash, wherein if the verification value matches the hash then the second device is in the locality of the first device.

13. A second device comprising:
a processor circuit and a memory circuit, wherein the memory is arranged to store instructions for the processor circuit,
wherein the processor circuit is arranged to obtain a secret,
wherein the processor circuit is arranged to generate an hash,
wherein the hash is generated by an irreversible encryption,
wherein the hash is based on the secret,
wherein the processor circuit is arranged to display a visual representation of the hash.

14. (canceled)

15. A method comprising: {second device; receiver}
obtaining a secret;
generating a hash,
wherein the hash is generated by an irreversible encryption,
wherein the hash is based on the secret; and
displaying a visual representation of the hash.

16. The method of claim 15,
wherein the generating of the hash comprises:
generating a second device timestamp value (T2); and
generating the hash based on the secret and the second device timestamp value.

17. The method of claim 16, further comprising: rounding the second timestamp values according to a target accuracy value.

18. The method of claim 15, further comprising: refreshing the visual representation, wherein the refreshing comprises regenerating of the hash periodically.

19. The method of claim 16, further comprising:
synchronizing a first reference clock of a first device; and
synchronizing a second reference clock,
wherein the first device timestamp value (T1) is generated base on the first synchronized reference clock,
wherein the second (T2) device timestamp value is generated based on the second synchronized reference clock.

20. The method of claim 15, wherein the displaying a visual representation of the hash comprises:
generating an image,
wherein the image comprises a watermark,
wherein the watermark comprises the hash; and
displaying the image as the visual representation.

21. The method of claim 20, wherein the watermark is a fragile watermark.

22. The method of claim 15, wherein the displaying a visual representation comprises:
generating a machine readable code, wherein the machine readable code comprises the hash; and
displaying the visual representation comprising the machine readable code.

23. The method of claim 15, wherein the machine-readable code is selected from the group consisting of a linear barcode and a two dimension matrix code.

24. A computer program stored on a non-transitory medium, wherein the computer program when executed on a processor performs the method as claimed in claim 15.

25. The first device of claim 12,
wherein the hash is based on the secret and a second device timestamp value (T2),
wherein the generating of the verification value comprises:
generating a first device timestamp value (T1); and
generating the verification value based on the secret and the first device timestamp value (T1).

26. The first device of claim 25, wherein the processor circuit is arranged to round at least one of the first timestamp value and the second timestamp value according to a target accuracy value.

27. The first device of claim 25,
wherein the processor circuit is arranged to synchronize a first reference clock,
wherein the processor circuit is arranged to synchronize a second reference clock of the second device,
wherein the first device timestamp value (T1) is generated base on the first synchronized reference clock,
wherein the second (T2) device timestamp value is generated based on the second synchronized reference clock.

28. The first device of claim 12,
wherein the processor circuit is arranged to detect the presence or absence of a watermark in the visual representation;
wherein the processor circuit is arranged to determine that the second device is not within the locality of the first device if the watermark is not detected in the visual representation; and
wherein the processor circuit is arranged to extract the hash from the watermark if the watermark is detected.

29. The first device of claim 12,
wherein the processor circuit is arranged to establish a communication link between a first device and a second device when the second device is in the locality of the first device,
wherein the processor circuit is arranged to prevent establishment of a communication link between the first device and the second device when the second device is not in the locality of the first device.

30. The second device of claim 13,
wherein the generating of the hash comprises:
generating a second device timestamp value (T2); and
generating the hash based on the secret and the second device timestamp value.

31. The second device of claim 30, wherein the processor circuit is arranged to round the second timestamp values according to a target accuracy value.

32. The second device of claim 13, wherein the processor circuit is arranged to refresh the visual representation, wherein the refreshing comprises regenerating of the hash periodically.

33. The second device of claim 30,
wherein the processor circuit is arranged to synchronize a first reference clock of a first device,
wherein the processor circuit is arranged to synchronizing a second reference clock,
wherein the first device timestamp value (T1) is generated base on the first synchronized reference clock,
wherein the second (T2) device timestamp value is generated based on the second synchronized reference clock.

34. The second device of claim 13, wherein the displaying a visual representation of the hash comprises:
generating an image,
wherein the image comprises a watermark,
wherein the watermark comprises the hash,
wherein the processor circuit is arranged to display the image as the visual representation.

35. The second device of claim 34, wherein the watermark is a fragile watermark.

36. The second device of claim 13, wherein the displaying a visual representation comprises:
generating a machine readable code, wherein the machine readable code comprises the hash; and
displaying the visual representation comprising the machine readable code.

37. The second device of claim 13, wherein the machine-readable code is selected from the group consisting of a linear barcode and a two dimension matrix code.
